(19) United States
(12) Patent Application Publication
(10) Pub. No.: US 2024/0249163 A1
(43) Pub. Date: Jul. 25, 2024

(54) Automated Responding To A Prompt In A Contact Center

(71) Applicant: Zoom Video Communications, Inc., San Jose, CA (US)

(72) Inventor: Alejandro Paiuk, West Hartford, CT (US)

(21) Appl. No.: 18/156,859

(22) Filed: Jan. 19, 2023

(51) Int. Cl. G06N 5/04; G10L 13/08; G10L 15/26

(52) U.S. Cl. CPC G06N 5/04; G10L 13/08; G10L 15/26

(57) ABSTRACT

A contact center server receives, during a contact center engagement and via a chat bot of the contact center server, a query from a user device. The contact center server determines that the query corresponds to a stored prompt associated with a stored response in a contact center knowledgebase. The contact center server provides, via the chat bot, the stored response to the user device.

### FIELD

This disclosure relates to techniques for automated question answering, for example, by automatically answering a question which is to be posted in communication software or transmitted to a contact center agent.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a contact center system.

FIG. 5 is a block diagram of an example of a system in which automated question answering in communication software may be performed.

FIG. 6 is a block diagram of an example of a system in which automated responding to prompts in a contact center may be performed.

FIG. 7 is a block diagram of an example of a system in which automated question answering may be performed.

FIG. 8A illustrates a first example graphical user interface (GUI) for creating a post to a communication modality.

FIG. 8B illustrates a second example GUI for creating a post to a communication modality.

FIG. 9 is a flowchart of an example of a technique for automatically responding to a query for posting to a communication modality.

FIG. 10 is a flowchart of an example of a technique for automatically responding to a query in a contact center.

### DETAILED DESCRIPTION

A business (or other entity) may have communication software (e.g., a team chat channel) where users (e.g., employees) may communicate about a topic (e.g., the employees' work). The communication software may be implemented over a unified communication as a service (UCaaS) system. Oftentimes, the same question is asked multiple times in the team chat channel, frustrating and wasting the time of the users or administrators of the team chat channel who answer the same question multiple times. For example, a new employee may ask a question about employee benefits (e.g., health insurance) that has already been answered by a human resources (HR) representative and is not useful to other employees who may have been using the benefits for many years. The new employee's question might not be answered, as other users of the communication software do not remember the answer or believe that it is someone else's job to provide the answer. Furthermore, it may be difficult for the new employee (or another person) to search for the right answer, as it might not be obvious where the right answer would be found. Unbeknownst to the employee, the answer might be stored in a directory (e.g., a benefit book of the health insurance company), but might be expressed using different words than those used by the employee (e.g., the language “out of pocket maximum” in the directory may correspond to the language “the most money I would have to pay” used by the employee), making it hard for the employee to get the answer even if they had access to the directory.

A team chat channel may include a text-based chat channel where users (e.g., employees of a company) may make posts. The team chat channel may have existed for multiple years and may have multiple questions and answers stored therein. However, going through the teams chat channel to locate relevant information may be cumbersome, as the team chat channel might be sorted by time, and might not have a high quality search functionality.

Implementations of this disclosure address problems such as these by building a knowledgebase storing question-answer pairs for questions that may be asked repeatedly in a communication channel facilitated over communication software (e.g., chat messaging). The knowledgebase may be built by having a natural language processing engine access the communication channel and identify question-answer pairs therein. The identified question-answer pairs may be stored in the knowledgebase. Furthermore, these identified question-answer pairs may occasionally be updated, for example, based on changes to company policies. The question-answer pairs in the knowledgebase may be organically generated based on communications in the communication software. When a question is asked and an answer is provided within the communication software, the question and the answer are stored in the knowledgebase. For example, a pair of chat messages respectively corresponding to a question and an answer may be entered into a chat conversation between members of a work team, in which case the question and answer may be used to generate a new entry for the knowledgebase. Alternatively, a question-answer pair may be manually added to the knowledgebase. For example, a human resources employee may notice that users are frequently asking how to adjust their retirement account contributions and may write an answer to this question (or answer the question using a medium different from writing, for example, by recording a video) for storage in the knowledgebase. In some cases, an administrator may remove organically-generated question-answer pairs from the knowledgebase, for example, if the question was answered incorrectly. The knowledgebase may be created specifically for the contents of the subject communication channel. For example, if a business has a communication channel for information technology (IT) issues, the knowledgebase may be created specifically to store question-answer pairs related to IT issues.

According to some implementations, a user of a user device enters a question into the communication software. For example, the user may access a page or an application associated with a team chat channel, and enter a post into the team chat channel including a question. For example, the post may include the text, “What is the password renewal policy?” The entered question is processed by a chat bot either prior to posting to the communication software or after posting to the communication software. Posting to the communication software includes the post being added to an online storage medium associated with the communication software, from where it is accessible to other users viewing the communication software. The chat bot accesses the knowledgebase and determines whether the entered question or a semantically similar question is represented in the knowledgebase. To determine whether the entered question is stored in the knowledgebase, the entered question may be converted to a vector representing its meaning (e.g., using a semantic engine that implements natural language processing technology). The questions in the knowledgebase may be associated with vectors representing their meanings. If a vector of a stored question in the knowledgebase is within a threshold distance (in a multi-dimensional space) of the vector of the entered vector, then that question may correspond to the entered question. If a stored question is found to correspond to the entered question, the answer to the stored question is provided to the user device, and the user of the user device is prompted to forgo posting the question to the communication software. As a result, questions asked by users of a chat channel may be automatically answered, reducing the number of repeat questions presented in the chat channel, disruptions to conversations caused by the presence of repeat questions in the chat channel, and/or reducing the number of questions that may otherwise go unanswered in the chat channel. This may also improve the user experience of the chat channel user by allowing the user to ask questions without the fear of embarrassment where the question may socially be considered remedial or is one that has been frequently asked.

According to some implementations, in a contact center setting implemented using UCaaS, a contact center may allow users (e.g., customers of an entity, such as a bank, store, or other business) to communicate with agents assigned to represent the entity over at least one of text, chat, telephony, or video conferencing. When a user of a user device accesses the contact center, the user is prompted to provide a query representing why the user is accessing the contact center. The query is received by a chat bot of the contact center. The chat bot of the contact center determines whether the query corresponds to a stored question in a contact center knowledgebase. If the query corresponds to the stored question, the chat bot provides a stored answer (stored in association with the stored question in the contact center knowledgebase) to the user device. In some such cases, the chat bot determines that the query corresponds to the stored question by mapping the query to an input vector representing a meaning of the query using a semantic engine, and determining that a distance between the input vector and a stored vector corresponding to a meaning of the stored question is less than or equal to a threshold distance. As a result, queries provided by users of the contact center may be automatically answered reducing the number of user devices that are routed to agent devices for communicating with contact center agents. This may improve the user experience of the contact center by answering a user's questions more quickly and allowing users whose questions are not automatically answered to experience shorter wait times for connection to a contact center agent.

The contact center knowledgebase may store prompts and responses. The prompts and responses may be generated, using a natural language processing engine, based on recordings of past contact center engagements. In some cases, personally-identifying information (e.g., voice information, facial information, names, addresses, or account numbers) may be removed from the recording prior to storage in the contact center knowledgebase. In some cases, an administrator using a client device may manually add a prompt-response pair to the knowledgebase or modify a stored prompt-response pair (e.g., based on changes to the products or the services offered by the entity).

As used herein, the term “automated” may include, among other things, a technology being performed by a computer or another machine without requiring manual user input. For example, automated question answering may include a question being asked by a person, via a user device, and being answered automatically, for example, by a client-side or server-side software application accessible to the user device, without requiring that the question be addressed by a human.

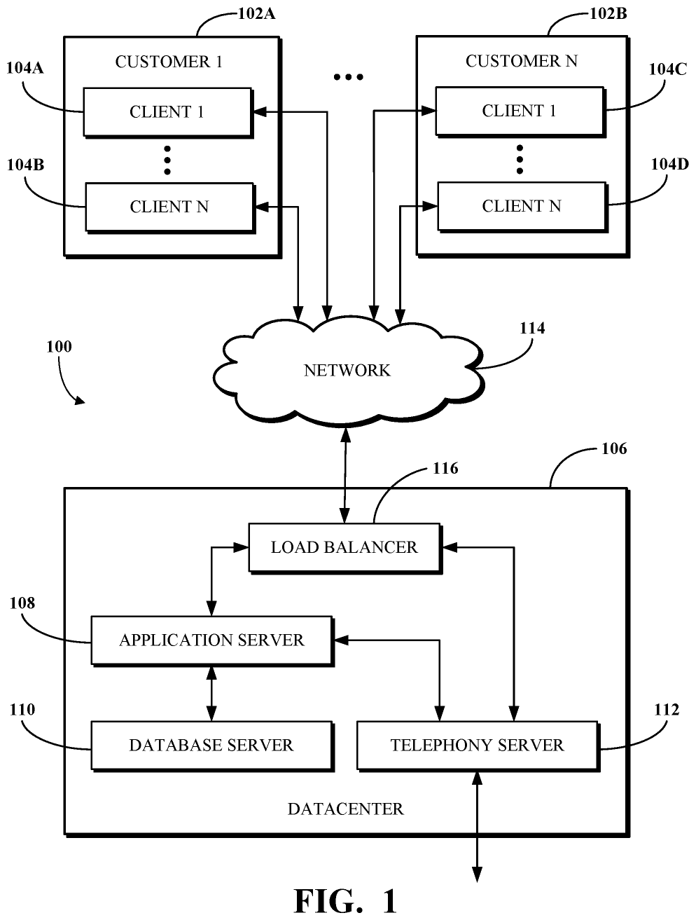

To describe some implementations in greater detail, reference is first made to examples of hardware and software structures used to implement a system for automated question answering. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

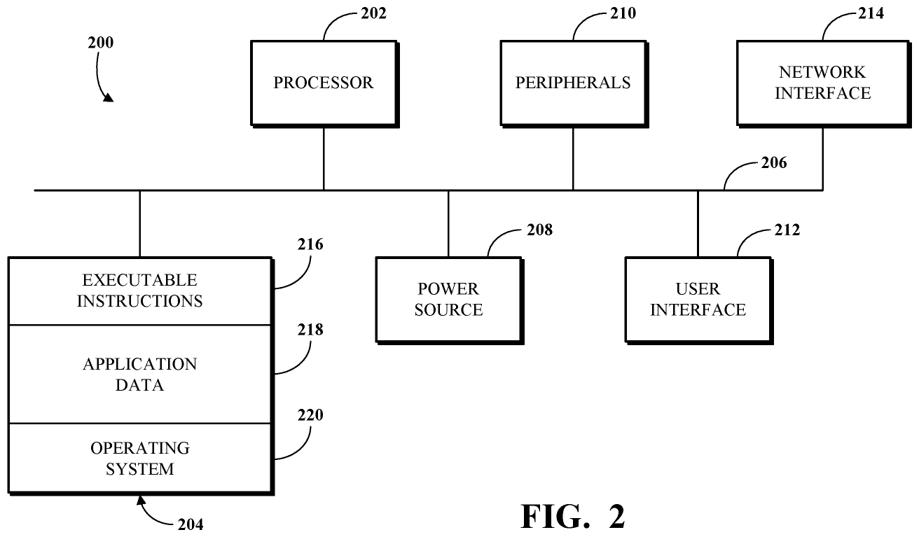

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may for example, be a positional input device, such as a mouse, touchpad, touchscreen, or the like; a keyboard; or another suitable human or machine interface device. An output interface may for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

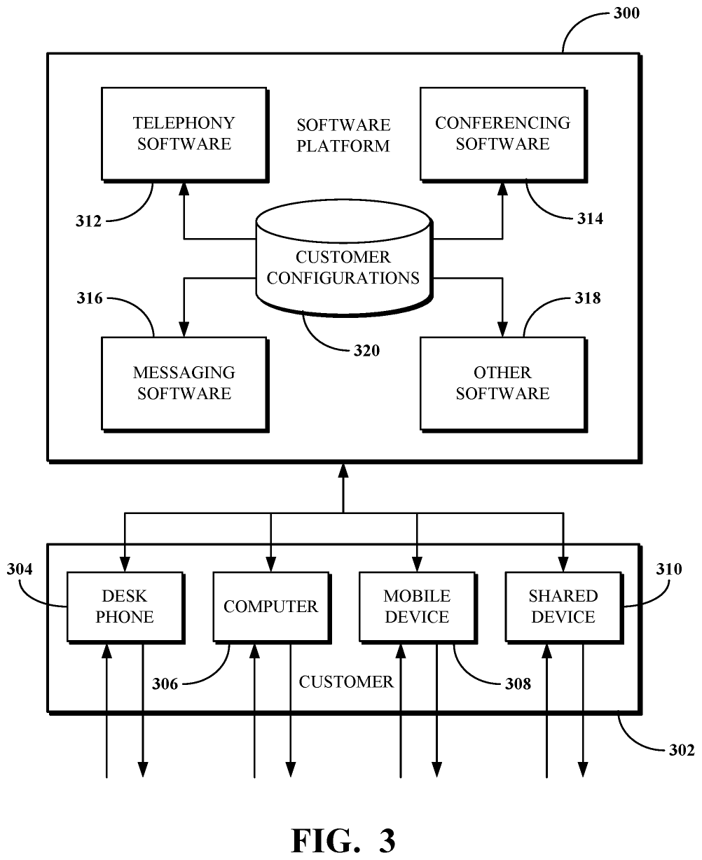

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may for example, refer to email messaging which includes a voicemail transcription service delivered in email format. The unified messaging functionality may include support for communication modalities (e.g., team chat channels or chat rooms) where a chat history between multiple participants may be stored over a long time. For example, a business may provide a communication modality for the human resources (HR) team, where HR-related topics may be discussed (both by members of the HR team and others who have questions for them). The HR communication modality may store hundreds or thousands text-based chat messages that were generated over multiple years, and may be updated as new chat messages are added to the HR communication modality.

The other software 318 enables other functionality of the software platform 300. Examples of the other software 318 include, but are not limited to, device management software, resource provisioning and deployment software, administrative software, third party integration software, and the like. In one particular example, the other software 318 can include software for automated question answering. In some such cases, the messaging software 316 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

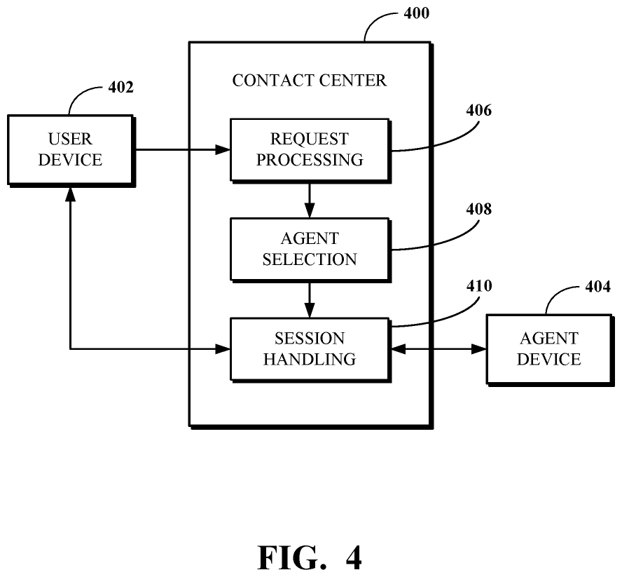

FIG. 4 is a block diagram of an example of a contact center system. A contact center 400, which in some cases may be implemented in connection with a software platform (e.g., the software platform 300 shown in FIG. 3), is accessed by a user device 402 and used to establish a connection between the user device 402 and an agent device 404 over one of multiple modalities available for use with the contact center 400, for example, telephony, video, text messaging, chat, and social media. The contact center 400 is implemented using one or more servers and software running thereon. For example, the contact center 400 may be implemented using one or more of the servers 108 through 112 shown in FIG. 1, and may use communication software such as or similar to the software 312 through 318 shown in FIG. 3. The contact center 400 includes software for facilitating contact center engagements requested by user devices such as the user device 402. As shown, the software includes request processing software 406, agent selection software 408, and session handling software 410.

The request processing software 406 processes a request for a contact center engagement initiated by the user device 402 to determine information associated with the request. The request may include a natural language query or a request entered in another manner (e.g., “press 1 to pay a bill, press 2 to request service”). The information associated with the request generally includes information identifying the purpose of the request and which is usable to direct the request traffic to a contact center agent capable of addressing the request. The information associated with the request may include information obtained from a user of the user device 402 after the request is initiated. For example, for the telephony modality, the request processing software 406 may use an interactive voice response (IVR) menu to prompt the user of the user device to present information associated with the purpose of the request, such as by identifying a category or sub-category of support requested. In another example, for the video modality, the request processing software 406 may use a form or other interactive user interface to prompt a user of the user device 402 to select options which correspond to the purpose of the request. In yet another example, for the chat modality, the request processing software 406 may ask the user of the user device 402 to summarize the purpose of the request (e.g., the natural language query) via text and thereafter process the text entered by the user device 402 using natural language processing and/or other processing.

The session handling software 410 establishes a connection between the user device 402 and the agent device 404, which is the device of the agent selected by the agent selection software 408. The particular manner of the connection and the process for establishing same may be based on the modality used for the contact center engagement requested by the user device 402. The contact center engagement is then facilitated over the established connection. For example, facilitating the contact center engagement over the established connection can include enabling the user of the user device 402 and the selected agent associated with the agent device 404 to engage in a discussion over the subject modality to address the purpose of the request from the user device 402. The facilitation of the contact center engagement over the established connection can use communication software implemented in connection with a software platform, for example, one of the software 312 through 318, or like software.

The user device 402 is a device configured to initiate a request for a contact center engagement which may be obtained and processed using the request processing software 406. In some cases, the user device 402 may be a client device, for example, one of the clients 304 through 310 shown in FIG. 3. For example, the user device 402 may use a client application running thereat to initiate the request for the contact center engagement. In another example, the connection between the user device 402 and the agent device 404 may be established using software available to a client application running at the user device 402. Alternatively, in some cases, the user device 402 may be other than a client device.

The agent device 404 is a device configured for use by a contact center agent. Where the contact center agent is a human, the agent device 404 is a device having a user interface. In some such cases, the agent device 404 may be a client device, for example, one of the clients 304 through 310, or a non-client device. In some such cases, the agent device 404 may be a server which implements software usable by one or more contact center agents to address contact center engagements requested by contact center users. Where the contact center agent is a non-human, the agent device 404 is a device that may or may not have a user interface. For example, in some such cases, the agent device 404 may be a server which implements software of or otherwise usable in connection with the contact center 400.

Although the request processing software 406, the agent selection software 408, and the session handling software 410 are shown as separate software components, in some implementations, some or all of the request processing software 406, the agent selection software 408, and the session handling software 410 may be combined. For example, the contact center 400 may be or include a single software component which performs the functionality of all of the request processing software 406, the agent selection software 408, and the session handling software 410. In some implementations, one or more of the request processing software 406, the agent selection software 408, or the session handling software 410 may be comprised of multiple software components. In some implementations, the contact center 400 may include software components other than the request processing software 406, the agent selection software 408, and the session handling software 410, such as in addition to or in place of one or more of the request processing software 406, the agent selection software 408, and the session handling software 410.

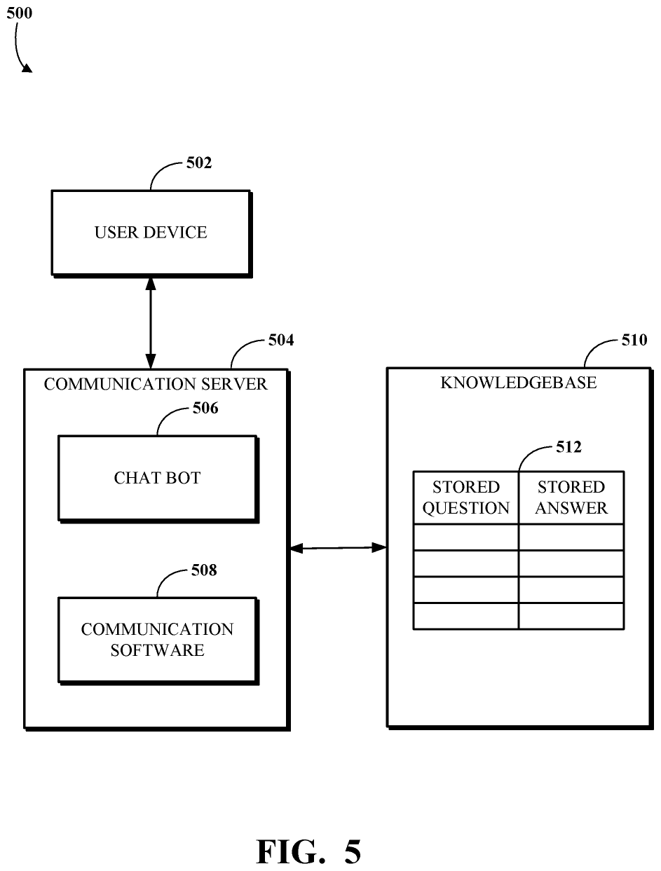

FIG. 5 is a block diagram of an example of a system 500 in which automated question answering in a communication software may be performed. The system 500 may be implemented using UCaaS, as described in conjunction with FIGS. 1-3. As shown, the system 500 includes a user device 502 and a communication server 504. The user device 502 may be a device operated by a user for text, audio or video communication with the communication server 504, and may correspond to one of the clients 104A-D, the computer 306, the mobile device 308, or the shared device 310. The communication server 504 may correspond to the application server 108 or the messaging software 316. As illustrated, the communication server 504 includes a chat bot 506 and a communication software 508. The chat bot 506 may automatically process communications from the user device 502, for example, by automatically providing answers to questions, as described in detail below. The chat bot 506 may thus be configured to engage in text-based communications with a user of the user device 502. The chat bot 506 may for example, include a natural language processing engine that processes natural language input (e.g., from the user device 502) and generates a response thereto. The communication software 508 may include a communication feed or a communication stream, for example, a team chat channel (e.g., a workplace chat channel or another chat channel) for a group of co-workers at an entity (e.g., a business or other organization) or a communication feed or a communication stream of a social media page associated with an entity. The communication software 508 may include a chat room that may be freely entered and exited by various user or a chat channel that may require a user to be admitted thereto in order to view and create posts. For example, a business may host a chat room where any users may discuss the products and services of the business. The business may also host a chat channel for employees of the business to discuss their work. The chat channel may only be accessible by employees of the business, and not by the general public. The communication software 508 may include software or hardware for making posts to the communication feed or the communication stream. While the communication software 508 is illustrated as residing at the communication server 504, in some cases, all or a part of the communication feed or the communication stream may be stored at one or more data repositories (e.g., databases or other data storage units) external to the communication server 504 which are accessible via the communication server 504.

As shown, the system 500 also includes a knowledgebase 510. The knowledgebase 510 may be implemented using a database or another data storage unit. As illustrated, the knowledgebase 510 includes a data structure 512 mapping stored questions to stored answers. The data structure 512 may be a table, a matrix, an index, or another data structure. The stored questions may be questions that were asked via the communication software 508 and the stored answers may be answers to those questions that were provided via the communication software 508 (e.g., as identified by an artificial intelligence engine or a statistical engine that accesses posts in the communication software 508). The stored answers may in some cases be reviewed or edited for accuracy, for example, via an administrator device associated with the communication software 508. In some cases, the administrator device may manually add additional questions and answers for storage in the data structure 512. For example, if a business is changing the health insurance provider for its employees, an administrator of the business may via the administrator device, add some anticipated questions and answers to the knowledgebase 512. In some cases, a client device of a senior administrator may transmit, to an administrator device of a junior administrator and via the communication server 504, a question to be added to the stored questions. The client device may also transmit, to the administrator device, a prompt for the junior administrator to generate a stored answer to the stored question for storage in the knowledgebase 510.

According to some implementations, the user device 502 accesses an application or a webpage associated with the communication software 508. A user of the user device 502 begins typing a post to the communication software 508 into a text box for typing the post. The data typed into the text box (the post or the beginning of the post that was typed by the user) is transmitted to the communication server 504 and accessed by the chat bot 506.

The chat bot 506 determines (e.g., using artificial intelligence techniques, for example, natural language processing (NLP) techniques) that the post corresponds to a stored question in the data structure 512 of the knowledgebase 510. In some cases, the chat bot 506 maps, using a semantic engine, the post to an input vector representing the meaning of the post. The chat bot 506 determines that a distance (within a multi-dimensional space) between the input vector and a stored vector corresponding to a meaning of a stored question in the data structure 512 is less than or equal to a threshold distance. In some cases, the semantic engine is configured to only handle natural language queries in a single natural language (e.g., English). Alternatively, the semantic engine may be configured to handle natural language queries in multiple different natural languages (e.g., English, Spanish, and Chinese) and to convert each query, regardless of its language, into an input vector representing the meaning of the query. For example, the queries “Where is the restaurant?” and “¿Donde está el restaurante?” (“Where is the restaurant?” in Spanish) would correspond to the same input vector.

The semantic engine is configured to map text (or speech) in a natural language (e.g., a spoken language or a written language, such as English, French, or German) to a vector that represents the meaning of the text. Texts that have similar meanings are mapped to vectors that are close to one another, while texts that have distinct meanings are mapped to vectors that are distant from one another.

Upon identifying the stored question corresponding to the post, the chat bot 506 transmits a stored answer to the stored question (from the data structure 512) to the user device 502 for display at the user device 502, for example, in a sidebar of a window (or other part of a graphical output) of the user device 502 for posting to the communication software 508. The chat bot 506 may transmit, to the user device 502, a prompt to forgo posting the post to the communication software 508 (to avoid wasting times of other users of the communication software 508, as the question in the post has already been answered). The user of the user advice 502 may accept the prompt. Alternatively, if the stored answer does not address the post (e.g., due to an incorrect matching of the post to the stored question or an incorrect matching of the stored question to the stored answer), the user of the user device may request (via the GUI output at the user device 502) posting of the post to the communication software 508.

Transmitting the stored answer to the stored question may include transmitting a written or recorded (e.g., audio or video) answer directly to the user device 502. Alternatively, the communication server 504 may transmit a link to a page (e.g., a webpage) including text, a video, or other audio or visual data representing the stored answer to the user device 502. The user device 502 may then access the page via the link, for example, in response to a selection of the link via the GUI output at the user device 502.

The knowledgebase 510 may be built based on posts made to the communication software 508. In some implementations, a natural language processing (NLP) engine access the posts and identifies question-answer pairs in the posts. The identified question-answer pairs are stored in the knowledgebase 510. In some cases, the question-answer pairs may be manually updated by a user (e.g., an administrator). For example, if the password renewal policy is updated to have users update their password once every two months instead of once per month, the administrator man manually access the knowledgebase 510 and adjust answers to questions about the password renewal policy accordingly. In some cases, a user (e.g., an administrator) may manually add a question-answer pairs to the knowledgebase 510. For example, if a business is transitioning from one retirement account brokerage to another, the new retirement account brokerage may provide a set of frequently asked questions that employees might have about the transition. Question-answer pairs corresponding to the frequently asked questions and their answers may be manually added to the knowledgebase 510.

In one example use case, ABC Corporation has a team chat channel for employees of ABC to discuss their work. The team chat channel is accessible from the employee's computing devices (e.g., laptop computers or mobile phones) using UCaaS technology. For example, the team chat channel may correspond to messaging software (e.g., the messaging software 316) of a software platform (e.g., the software platform 300). Ben Bitdiddle, a new employee of ABC Corporation, accesses a webpage of the team chat channel via his laptop computer, types, “Where is the accounting department?” into a post input box of the webpage, and clicks a post button on the webpage.

After Ben clicks the post button, the query “Where is the accounting department?” is transmitted from Ben's laptop computer to the communication server 504. At the communication server 504, the chat bot 506 processes the query to determine whether the query corresponds to a stored question in the knowledgebase 510. Using NLP, the chat bot determines that the structure of the query includes the word “Where,” and the name of a thing that is found in the office building. This corresponds to a stored question in the knowledgebase—“Where are things in the office?”—which maps to a stored answer that includes a printable map of each floor of office.

Prior to posting the query to the team chat channel, the chat bot 506 transmits visual data indicating the stored question—“Where are things in the office?”—and the stored answer—the printable map—to Ben's laptop computer. For example, the visual data may be presented, at Ben's laptop computer, in a sidebar of the window (or other part of a graphical output) for adding posts to the team chat channel. The sidebar may occupy the n rightmost or leftmost pixels of each row of pixels of the window, where n is a positive integer. Upon receiving the visual data, Ben is able, using his laptop computer, either to accept the visual data as adequately answering the query or to proceed with posting the query to the team chat channel. Specifically, Ben's laptop computer is configured, based on a user input, to download, display, or print the printable map. Alternatively, if the printable map does not include an answer to the query (e.g., does not indicate the location of the accounting department), Ben's laptop computer is configured to receive a user input for proceeding with posting the query to the team chat channel.

As a result of some implementations, some questions that are written for posting to the team chat channel are answered automatically and not posted to the team chat channel. This reduces distractions to other users of the team chat channel increases the relevance of posts in the team chat channel to other users thereof.

The above example use case includes a question that was correctly mapped to a stored question in the knowledgebase 510. However, in alternative implementations, some questions might not map to any questions in the knowledgebase 510. For example, if ABC Corporation were offering health insurance to its employees for the first time, and Ben Bitdiddle asked the query, “How do I sign up for health insurance,” this question might not correspond to a stored question in the knowledgebase 510. In this case, the chat bot would not recognize any stored questions for this query, and the query would be posted to the team chat channel, allowing other employees of ABC Corporation to access and/or to answer the question. In this case, the chat bot 506 may create a new knowledgebase record for the new question when an answer to the new question is received. The chat bot 506 may create the new knowledgebase record automatically. Alternatively, the chat bot 506 may prompt a user of an administrator device to confirm that the new knowledgebase record should be created and create the new knowledgebase record in response to receiving the confirmation.

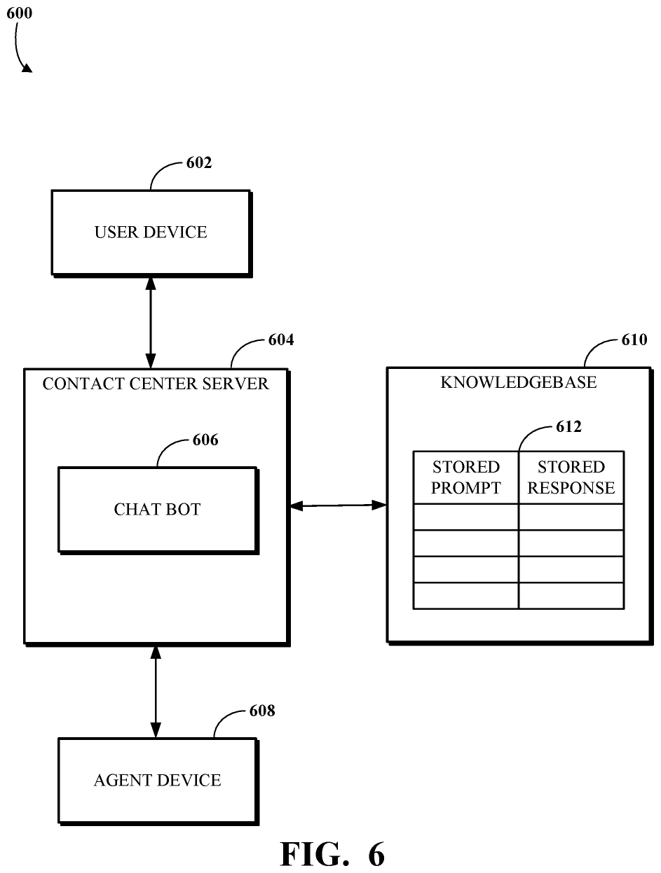

FIG. 6 is a block diagram of an example of a system 600 in which automated responding to prompts in a contact center may be performed. As shown, the system 600 includes a user device 602, a contact center server 604 including a chat bot 606, an agent device 608, and a knowledgebase 610 storing a data structure 612 mapping stored prompts to stored responses. The stored prompts may correspond to stored questions, as described in conjunction with FIG. 5. The stored responses may correspond to stored answers, s described in conjunction with FIG. 5. The user device 602 may correspond to the user device 402 and/or one of the clients 104A-D. The contact center server 604 may be associated with the contact center 400 and may perform at least one of request processing 406, agent selection 408, or session handling 410. The contact center server 604 may correspond to the application server 108. The agent device 608 may correspond to the agent device 404 and/or one of the clients 104A-D. The knowledgebase 610 may be similar, in structure and/or function, to the knowledgebase 510. The data structure 612 may be similar, in structure and/or function, to the data structure 512.

The data structure 612 may be any data structure, for example, at least one of a table, an array, a matrix, or a list. As shown, the data structure 612 includes stored prompts and stored responses. The stored prompts and stored responses may correspond to recordings of communications between user devices and agent devices facilitated by the contact center server 604. The recordings of the communications may be edited (e.g., by an administrator) to remove private or personally identifiable information, and may be verified to be accurate by the administrator. The recordings are generated after all parties are notified and provide affirmative consent. In a video conference, a persistent visual notification (e.g., an on-screen icon or other visual mark) may be provided to indicate that the recording is ongoing. The recordings may be adjusted to remove the visual imagery, the voice, and/or the unique speech patterns of the user of the user device in the recording. For example, the recordings may be converted from an audio or a video format to text using speech-to-text technology. Alternatively or in addition, some of the stored prompts and associated stored responses may be manually added to the data structure 612 by an administrator accessing the knowledgebase 610 from an administrator device.

According to some implementations, to add a stored prompt and a stored response to the data structure 612, the contact center server 604 records a contact center engagement between a client device (e.g., the user device 602 or another device) and an agent device (e.g., the agent device 608 or another agent device). The contact center server 604 determines, using an artificial intelligence engine (e.g., a convolutional neural network or another structure implementing artificial intelligence technology), a prompt of a user of the client device and a response provided by the agent at the agent device. The contact center server 604 removes, from the prompt and from the response, personally identifiable information of the user, voice information of the user, and/or imagery of the user. The prompt and the response are then stored in the data structure 612 of the contact center knowledgebase 610. Alternatively or in addition to the above, an administrator using an administrator device may manually generate a prompt and a response and transmit the manually generated prompt and response to the contact center server 604. The contact center server 604 may then store the manually generated stored prompt and stored response in the contact center knowledgebase 610.

In one example, the artificial intelligence engine may be an artificial neural network that is trained using supervised learning based on prompts and responses in recordings that are identified by humans. In one example, the artificial intelligence engine (or another artificial intelligence engine) automatically removes the personally identifiable information of the user, the voice information of the user, and/or the imagery of the user. Alternatively, these may be manually removed by an administrator associated with a business (or other entity) using the contact center.

According to some implementations, the user device 602 accesses the contact center server 604 to communicate with an entity (e.g., a business) associated with the contact center server 604 using at least one of text chat, voice conferencing or video conferencing. For example, the user device 602 may in response to a user input at the user device 602, dial a telephone number associated with the entity or initiate communication with the entity via a text messaging application or a video conferencing application.

Upon connection of the user device 602 with the contact center server 604, the chat bot 606 provides audio, video, or text prompting a user of the user device 602 to specify a reason why they are accessing the contact center. In response, the user of the user device 602 speaks or types a query which is transmitted, via the user device 602, to the chat bot 606. In some cases, the query is received, from the user device 602, as text. Alternatively, the query may be received, from the user device 602, as audio or video. A speech-to-text engine may be used to convert the received audio or video query into a text query for further processing as described below. The speech-to-text engine may use artificial intelligence (e.g., NLP) techniques to identify text that corresponds to speech in a natural language (e.g., English or Spanish).

The chat bot 606 is configured to perform text, audio, or video-based communication with the user device 602. (Video-based communication may be accomplished, for example, using a computer-generated animation of character that has human-like facial features and moves its mouth when generating audio output.) The chat bot 606 may include a natural language processing engine that receives natural language input and generates a natural language response to the input. The chat bot 606 may be used to automatically respond to queries (e.g., as described herein) or to route the user device 602 to an appropriate agent device based on natural language input from the user device. For example, in a technical support center, the chat bot 606 may route the user device 602 to an appropriate agent device based on an operating system of a machine about which the user is inquiring and/or a software product about which the user is inquiring.

The chat bot 606 determines whether the query corresponds to a stored prompt in the data structure 612 of the knowledgebase 610 coupled with the contact center server 604. The determination may be made by mapping the query to an input vector representing a meaning of the query using a semantic engine, and determining that a distance between the input vector and a stored vector corresponding to a meaning of the stored prompt is less than or equal to a threshold distance.

If the chat bot 606 determines that the query corresponds to the stored prompt, the chat bot 606 transmits the stored response and, in some cases, also the stored prompt, to the user device 602. At the user device 602, the user is prompted to specify whether the stored response properly responded to their prompt. If the user acknowledges that the stored response properly responded to their prompt, the user device 602 is not connected to the agent device 608. If the user denies that the stored response properly responded to their prompt, the user device 602 is connected to the agent device 608 or is added to a waitlist for connection to the agent device 608.

The stored response may be automatically transmitted via text (or played via audio or video) to the user device 602 by the chat bot 606. Alternatively, the chat bot 606 may provide, to the user device 602, a link to a page (e.g., a webpage) that includes text, audio, video data representing or including the stored response. The user of the user device 602 may select the link in order to view the associated page and access the stored response.

If the chat bot 606 determines that the query does not correspond to the stored prompt, the user device 602 is connected to the agent device 608 or is added to a waitlist for connection to the agent device 608. When the agent device 608 is connected with the user device 602, the agent device 608 is provided with the query to inform the agent using the agent device of why the user is accessing the contact center.

In some cases, multiple agent devices (including the agent device 608) are available, and the query may be used to select a set of agent devices to which the user device 602 should be routed. For example, if the contact center server 604 is associated with a bank that has savings accounts and mortgage accounts, the query may be used to determine whether the user device 602 should be routed to an agent device of an agent specializing in savings accounts or an agent device of an agent specializing in mortgage accounts.

In one example use case, a user telephones a contact center of a supermarket. The user's telephone call is answered by the chat bot 606 of the supermarket which asks the user why they are calling. In response, the user states, “What are the supermarket's hours on New Year's Day?” The chat bot uses a speech-to-text engine to convert the user's oral statement to text, and the text is stored as the query. The chat bot accesses the knowledgebase 610 and determines that there is a stored prompt in the knowledgebase 610—“What are the store hours?”—which is proximate in meaning (e.g., based on a distance between vectors corresponding to meaning, as described above) to “What are the supermarket's hours on New Year's Day?” The chat bot 606 plays a recording of the stored prompt and the stored response to the stored prompt to the user's telephone. After the recording, the user is prompted to specify (e.g., by dialing specified digits on the telephone keypad) whether they received an acceptable response to their query.

If the user specifies that the response is proper, (e.g., if the recording includes a statement of the supermarket's hours on New Year's Day) the user's telephone call is terminated or the user is prompted to specify another query. If the user specifies that the response to their query was not acceptable, (e.g., if the recording does not include a statement of the supermarket's hours on New Year's Day or the user did not understand the stated hours) the user's telephone is connected to the agent device 608 of an agent of the supermarket or added to a waitlist for connection to the agent device 608. If a user indicates that a response is not proper, it can potentially initiate a “human-in-the-loop” interception. An administrator (via an administrator device) could set parameters such that if X users (where X is a positive integer) mark a response as not proper, the question-answer pair must be manually reviewed, whereby the reviewer could then update the response if needed or mark it as validated if not.

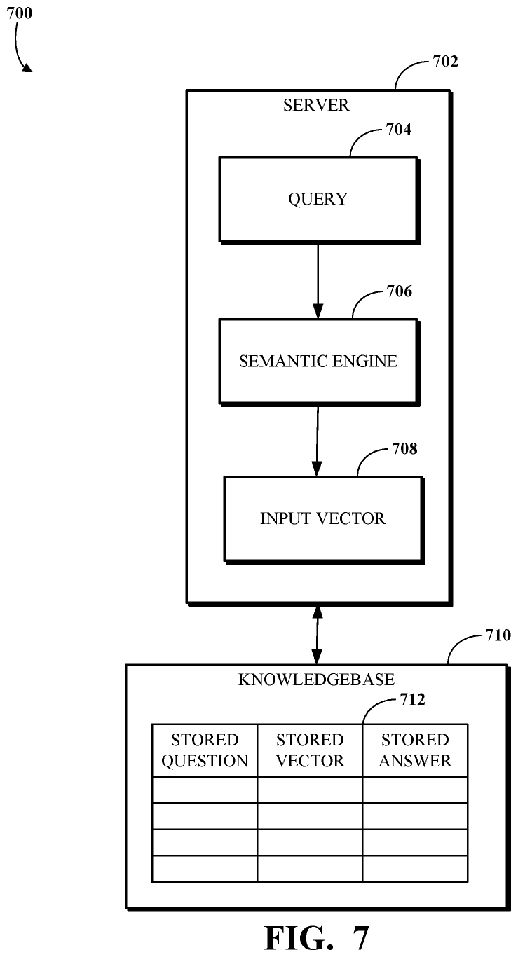

FIG. 7 is a block diagram of an example of a system 700 in which automated question answering may be performed. The system 700 may be implemented within the system 500 or the system 600. As shown, the system 700 includes a server 702, which stores a query 704, a semantic engine 706, and an input vector 708. The server 702 is capable of communication (e.g., via a network or a direct hardwired connection) with a knowledgebase 710, which stores a data structure 712 representing stored questions in association with stored vectors and stored answers. The server 702 may correspond to the communication server 504 or the contact center server 604. The knowledgebase 710 may correspond to the knowledgebase 510 or the knowledgebase 610. The data structure 712 may correspond to the data structure 512 or the data structure 612. In the data structure 612, the stored prompts may correspond to the stored questions of the data structure 712, and the stored responses may correspond to the stored answers of the data structure 712.

As shown in FIG. 7, the server 702 accesses (e.g., from the user device 502 or the user device 602) the query 704. The server 702 provides the query 704 to the semantic engine 706. The semantic engine 706 uses NLP or other artificial intelligence, machine learning, or statistical technology to compute the input vector 708 corresponding to the meaning of the query 704. The input vector 708 is a set of numbers that represent the meaning of the query 704. In some examples, the semantic engine 706 includes a convolutional neural network. The input vector 708 may be determined based on the at least one of the words, the sub-words (e.g., prefixes, suffixes or other parts of words), and the punctuation marks in the query 704. Queries that have the same meaning (e.g., “Where is the lawyer's house?” and “Where is the attorney's home?”) may map to the same input vector. Queries that are similar in meaning (e.g., “Where is the apartment building?” and “Where is the condominium complex?”) may map to input vectors that have a smaller distance to one another than queries that are distant in meaning (e.g., “Where is the apartment building?” and “How do I cook the frozen pizza?”).

After the input vector 708 is computed by the semantic engine 706, the server 702 accesses the data structure 712 in the knowledgebase 710 and identifies a stored vector that is less than or equal to a threshold distance from the input vector 708. If no such stored vector is available, the server 702 determines that the query 704 does not map to any stored questions and attempts to answer the query 704 by other techniques (e.g., posting to a communication software or forwarding to an agent device). If at least one such stored vector is available, the corresponding at least one stored question and at least one stored answer are transmitted to the user device by the server 702.

As illustrated, the data structure 712 (along with the data structure 512 and the data structure 612) is a table. However, other data structure types (e.g., an array, a matrix, or a linked list) may also be used to implement the data structure 712. As shown, the data structure 712 includes stored questions and stored answers, which may be generated based on posts in a communication software or recordings of communications with agents, as described above. The stored vector for each stored question may be calculated by the semantic engine 706, with the input to the semantic engine 712 being the stored question instead of the query 704.

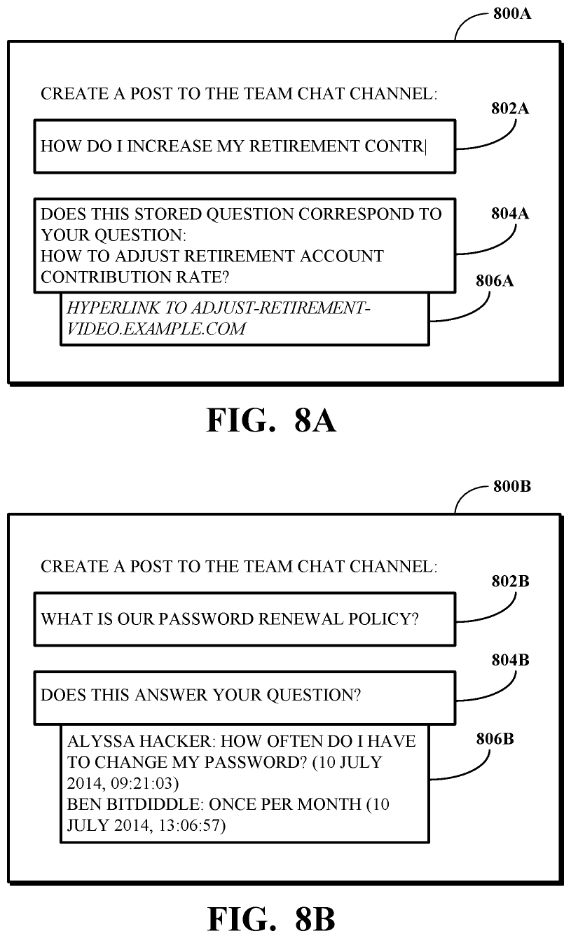

FIG. 8A illustrates a first example GUI 800A for creating a post to a team chat channel. The GUI 800A may be presented at the user device 502. As shown, the GUI 800A includes an input box 802A where the user is to type a post to the team chat channel. As shown, the user has typed, “HOW DO I INCREASE MY RETIREMENT CONTR,” and is continuing to type into the input box 802A. The text typed by the user is accessed by the communication server 504 while the user is typing (e.g., before the user has finished typing the word “CONTRIBUTION”). In response, the communication server 504 identifies a stored question (from the knowledgebase 510) that is likely to correspond to the text typed by the user in the box 802A. The identified stored question is presented at box 804A, which may overlay a “post” button for posting the text typed by the user to the team chat channel. A hyperlink to the stored answer associated with the stored question is also presented on the GUI 800A at box 806A.

As a result, if the query (at input box 802A) is answered, the user may access, via the user device 502, the hyperlink at box 806A to receive the answer to the query. Alternatively, if the user believes that the query is not answered, the user may remove (e.g., by swiping left on a touch screen interface) the box 804A and/or the box 806A in order to reveal the “post” button to post the text in the input box to the team chat channel.

FIG. 8B illustrates a second example GUI 800B for creating a post to a team chat channel. The GUI 800B may be presented at the user device 502. As shown, the GUI 800B includes an input box 802B where the user is to type a post to the team chat channel. As shown, the user has typed, “WHAT IS OUR PASSWORD RENEWAL POLICY?” In response, the communication server 504 identifies a stored question (from the knowledgebase 510) that corresponds to a previous chat in the team chat channel and is likely to correspond to the text typed by the user in the input box 802B. Box 804B prompts the user to verify whether this answers their question, and box 806B includes the text from the previous chat in the team chat channel. As shown, the box 806B specifies the names of the participants in the chat, the text typed by the participants, and the date and time when the text was typed. If the user's question at box 802B is properly answered by the information at box 806B, the user may forego posting the question to the team chat channel, saving other users of the team chat channel from seeing information that might not be relevant or useful to them.

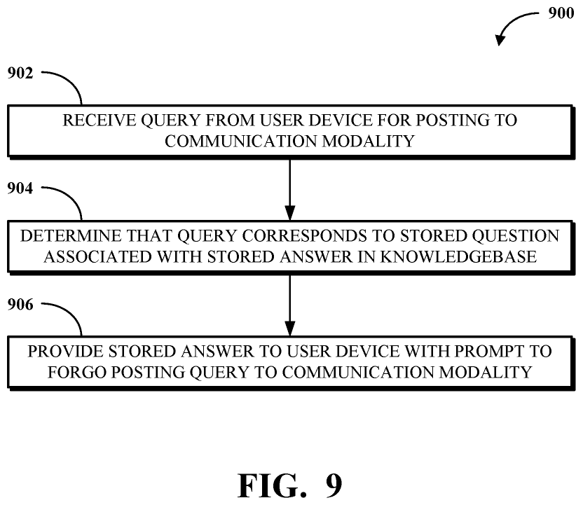

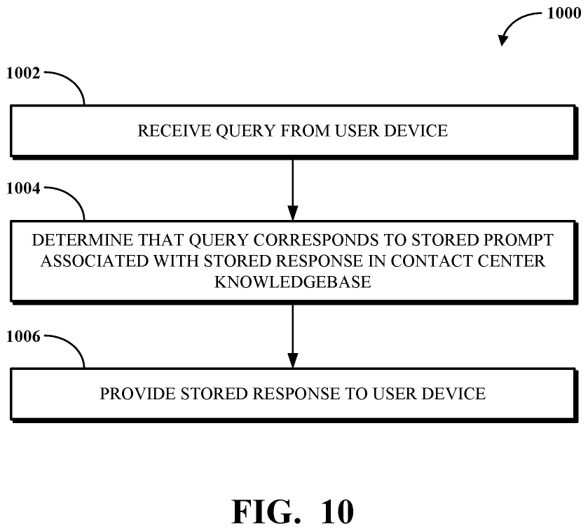

To further describe some implementations in greater detail, reference is next made to examples of techniques for automated question answering. FIG. 9 is a flowchart of an example of a technique 900 for automatically responding to a query for posting to a communication modality. FIG. 10 is a flowchart of an example of a technique for automatically responding to a query in a contact center. The techniques 900 and/or 1000 can be executed using computing devices, such as the systems, hardware, and software described with respect to FIGS. 1-8. The techniques 900 and/or 1000 can be performed, for example, by executing a machine-readable program or other computer-executable instructions, such as routines, instructions, programs, or other code. The steps, or operations, of the techniques 900 and/or 1000 or another technique, method, process, or algorithm described in connection with the implementations disclosed herein can be implemented directly in hardware, firmware, software executed by hardware, circuitry, or a combination thereof.

For simplicity of explanation, the techniques 900 and 1000 are depicted and described herein as series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 9 is a flowchart of an example of the technique 900 for automatically responding to a query for posting to a communication modality.

At 902, a server (e.g., the communication server 504 or the server 702), via software running at the server and used to facilitate a real-time communication involving a user of a user device, receives a query from the user device. The query corresponds to text (or other data, such as audio or video data) for posting to a communication modality. The communication modality may be implemented using communication software, for example, the messaging software 316. For example, the communication modality may be a team chat channel of a business, a chat room, or a posting on a social media page associated with a business.

At 904, the server determines that the query corresponds to a stored question from a knowledgebase (e.g., the knowledgebase 510 or the knowledgebase 710). The stored question is associated with a stored answer. The query may correspond to the stored question based on at least one of a meaning of the query or the stored question, keywords in the query or the stored question, or a category associated with the query or the stored question. The category may correspond to a division of a business associated with the query or the stored question. For example, a banking business may be associated with the categories, checking, savings, vehicle financing, and mortgage. The category of the stored questions in the knowledgebase may be set by an administrator, and the category of the query may be specified by the user. According to some implementations, the server maps the query to an input vector representing the meaning of the query using a semantic engine. The server determines that the query corresponds to the stored question if a distance between the input vector and a stored vector corresponding to the meaning of the stored question is less than a threshold distance.

At 906, the server provides, to the user device, the stored answer associated with the stored question. The stored answer is provided with a prompt to forgo posting the query to the communication modality if the stored answer adequately responds to the query. The server may transmit the stored answer for display, audio playback, or video playback at the user device. In some examples, the stored answer includes text, audio or video content from one or more previous posts to the communication modality.

FIG. 10 is a flowchart of an example of the technique 1000 for automatically responding to a query in a contact center.

At 1002, a server (e.g., the contact center server 604 or the server 702) receives, via a chat bot (e.g., the chat bot 606) of the contact center, a query from a user device accessing the contact center. The query may be received upon initiation, by the user device, of a contact center engagement. Upon initiation of the contact center engagement, the chat bot may request that the user of the user device type or speak their reasons for initiating the contact center engagement and may record the response received from the user device (e.g., in text, audio or video format) as the query.

At 1004, the server determines that the query corresponds to a stored prompt associated with a stored response in a contact center knowledgebase (e.g., the knowledgebase 610 or the knowledgebase 710). For example, if the query is received in audio or video format, the query may be converted to text using a speech-to-text engine. The server then maps, using a semantic engine, the text query to an input vector representing the meaning of the text query. The server determines that the stored prompt corresponds to the query if a distance between the input vector and a stored vector corresponding to a meaning of the stored prompt is less than or equal to a threshold distance.

At 1006, the server provides the stored response to the user device. The stored response may be output to the user device. In some cases, speech-to-text or text-to-speech technology may be used to convert the stored response into a format accessible via the user device. For example, if the stored response includes a video and the user device is accessing the server via a PSTN call, the video may be converted to audio for playback via the PSTN. Alternatively, the user of the user device may be notified that a video response is available and the user of the user device may confirm a messaging address or a telephone number capable of receiving text messages for receiving the video response or a link to a webpage including the video response.

Some implementations are described below as numbered examples (Example 1, 2, 3, etc.). These examples are provided as examples only and do not limit the other implementations disclosed herein.

Example 1 is a method, comprising: receiving a query from a user device for posting to a communication modality; determining, using a chat bot associated with the communication modality, that the query corresponds to a stored question associated with a stored answer in a knowledgebase by: mapping the query to an input vector representing a meaning of the query using a semantic engine, and determining that a distance between the input vector and a stored vector corresponding to a meaning of the stored question is less than or equal to a threshold distance; and providing, via the chat bot, the stored answer to the user device with a prompt to forgo posting the query to the communication modality.

In Example 2, the subject matter of Example 1 includes, adding the stored question to the knowledgebase by: accessing, within the communication modality, the stored question and the stored answer; identifying, using an artificial intelligence engine, that the stored answer is responsive to the stored question; and storing the stored question in association with the stored answer in the knowledgebase.

In Example 3, the subject matter of Examples 1-2 includes, adding the stored question to the knowledgebase by: receiving, from an administrator device, the stored question and the stored answer for storage in the knowledgebase.

In Example 4, the subject matter of Examples 1-3 includes, the communication modality being a team chat channel.

In Example 5, the subject matter of Examples 1-4 includes, receiving the query comprising: accessing, by the chat bot, the query while the user is typing the query into an input box at a graphical user interface of the user device.

In Example 6, the subject matter of Examples 1-5 includes, the semantic engine being configured to map queries in multiple different natural languages to input vectors.

In Example 7, the subject matter of Examples 1-6 includes, providing the stored answer to the user device comprising: providing a link to a page comprising text or a video representing the stored answer.

Example 8 is a non-transitory computer readable medium storing instructions operable to cause one or more processors to perform operations comprising: receiving a query from a user device for posting to a communication modality; determining, using a chat bot associated with the communication modality, that the query corresponds to a stored question associated with a stored answer in a knowledgebase by: mapping the query to an input vector representing a meaning of the query using a semantic engine, and determining that a distance between the input vector and a stored vector corresponding to a meaning of the stored question is less than or equal to a threshold distance; and providing, via the chat bot, the stored answer to the user device with a prompt to forgo posting the query to the communication modality.

In Example 9, the subject matter of Example 8 includes, the operations comprising adding the stored question to the knowledgebase by: accessing the stored question and the stored answer within the communication modality; determining that the stored answer is responsive to the stored question; and storing, within the knowledgebase, the stored question and the stored answer.

In Example 10, the subject matter of Examples 8-9 includes, the operations comprising adding the stored question to the knowledgebase by: transmitting the stored question to an administrator device; and receiving, from the administrator device, the stored answer for storage in the knowledgebase.

In Example 11, the subject matter of Examples 8-10 includes, the communication modality being a workplace chat channel.

In Example 12, the subject matter of Examples 8-11 includes, receiving the query comprising: accessing the query while the user types the query into an input box at a graphical user interface of the user device.

In Example 13, the subject matter of Examples 8-12 includes, the semantic engine being configured to map queries in at least two different natural languages to input vectors.

In Example 14, the subject matter of Examples 8-13 includes, providing the stored answer to the user device comprising: providing a link to a page comprising a video representing the stored answer.

Example 15 is an apparatus comprising: a memory; and a processor configured to execute instructions stored in the memory to: receive a query from a user device for posting to a communication modality; determine, using a chat bot associated with the communication modality, that the query corresponds to a stored question associated with a stored answer in a knowledgebase by: mapping the query to an input vector representing a meaning of the query using a semantic engine, and determining that a distance between the input vector and a stored vector corresponding to a meaning of the stored question is less than or equal to a threshold distance; and provide, via the chat bot, the stored answer to the user device with a prompt to forgo posting the query to the communication modality.

In Example 16, the subject matter of Example 15 includes, the processor configured to execute the instructions stored in the memory to add the stored question to the knowledgebase by: accessing, within the communication modality, the stored question and the stored answer; identifying, using a statistical engine, that the stored answer is responsive to the stored question; and storing the stored question in association with the stored answer in the knowledgebase.

In Example 17, the subject matter of Examples 15-16 includes, the processor configured to execute the instructions stored in the memory to add the stored question to the knowledgebase by: receiving, at the apparatus, the stored question and the stored answer for storage in the knowledgebase.

In Example 18, the subject matter of Examples 15-17 includes, the communication modality being a chat channel.

In Example 19, the subject matter of Examples 15-18 includes, receiving the query comprising: accessing, by the chat bot, the query while the user is typing the query at a graphical user interface of the user device.

In Example 20, the subject matter of Examples 15-19 includes, providing the stored answer to the user device comprising: providing a link to a page comprising audio or visual data representing the stored answer.

Example 21 is a method comprising: receiving, during a contact center engagement and via a chat bot of a contact center server, a query from a user device; determining that the query corresponds to a stored prompt associated with a stored response in a contact center knowledgebase by: mapping the query to an input vector representing a meaning of the query using a semantic engine, and determining that a distance between the input vector and a stored vector corresponding to a meaning of the stored prompt is less than or equal to a threshold distance; and providing, via the chat bot, the stored response to the user device.

In Example 22, the subject matter of Example 21 includes, wherein the query comprises text, wherein receiving the query from the user device comprises: receiving a query comprising audio from the user device; and generating the query comprising text by applying a speech-to-text engine to the received query comprising audio.

In Example 23, the subject matter of Examples 21-22 includes, wherein receiving the query from the user device comprises: prompting a user of the user device to specify a reason for the contact center engagement; and receiving the query in response to prompting the user.

In Example 24, the subject matter of Examples 21-23 includes, wherein the chat bot is configured, using a natural language processing engine, to perform audio communication in a spoken language.

In Example 25, the subject matter of Examples 21-24 includes, wherein providing the stored response to the user device comprises: providing a link to a page including a representation of the stored response.

Example 26 is a non-transitory computer readable medium storing instructions operable to cause one or more processors to perform operations comprising: receiving, during a contact center engagement and via a chat bot of a contact center server, a query from a user device; determining that the query corresponds to a stored prompt associated with a stored response in a contact center knowledgebase by: mapping the query to an input vector representing a meaning of the query using a semantic engine, and determining that a distance between the input vector and a stored vector corresponding to a meaning of the stored prompt is less than or equal to a threshold distance; and providing, via the chat bot, the stored response to the user device.

In Example 27, the subject matter of Example 26 includes, wherein the query comprises text, wherein receiving the query from the user device comprises: receiving an audio or video query from the user device; and generating the query by applying a speech-to-text engine to the received audio or video query.

In Example 28, the subject matter of Examples 26-27 includes, the operations comprising: adding the stored prompt and the stored response to the contact center knowledgebase by: recording a contact center engagement between a second user device and an agent device; determining, using an artificial intelligence engine, a question of a user of the second user device and an answer provided by the agent of the agent device; removing, from the question and from the answer by the artificial intelligence engine, at least one of: personally identifiable information of the user, voice information of the user, or imagery of the user; and storing, in the contact center knowledgebase, the question and the answer as the stored prompt and the stored response.

In Example 29, the subject matter of Examples 26-28 includes, the operations comprising: adding the stored prompt and the stored response to the contact center knowledgebase by: receiving, from an administrator device, a question and an answer; and storing the received question and the received answer as the stored prompt and the stored response in the contact center knowledgebase.

In Example 30, the subject matter of Examples 26-29 includes, wherein receiving the query from the user device comprises: prompting, by the chat bot, a user of the user device to specify a reason for the contact center engagement; and receiving the query in response to prompting the user.

In Example 31, the subject matter of Examples 26-30 includes, wherein the chat bot is configured, using a natural language processing engine, to perform at least one of text communication or audio communication in a natural language.

In Example 32, the subject matter of Examples 26-31 includes, wherein providing the stored response to the user device comprises: providing a link to a video representing the stored response.

Example 33 is an apparatus comprising: a memory; and a processor configured to execute instructions stored in the memory to: receive, during a contact center engagement and via a chat bot of a contact center server, a query from a user device; determine that the query corresponds to a stored prompt associated with a stored response in a contact center knowledgebase by: mapping the query to an input vector representing a meaning of the query using a semantic engine, and determining that a distance between the input vector and a stored vector corresponding to a meaning of the stored prompt is less than or equal to a threshold distance; and provide, via the chat bot, the stored response to the user device.

In Example 34, the subject matter of Example 33 includes, wherein the processor is configured to execute instructions stored in the memory to: determine that the query does not correspond to the stored prompt in the data repository; and transmit the question to an agent device for manual processing in response to determining that the query does not correspond to the stored prompt.

In Example 35, the subject matter of Examples 33-34 includes, wherein the query is a text query, wherein receiving the query from the user device comprises: receiving an audio or video query from the user device; and generating the text query by applying a speech-to-text engine to the received audio or video query.

In Example 36, the subject matter of Examples 33-35 includes, wherein the processor is configured to execute instructions stored in the memory to: add the stored prompt and the stored response to the contact center knowledgebase by: recording a contact center engagement between a client device and an agent device; determining, using an artificial intelligence engine, a question of a user of the client device and an answer provided by the agent of the agent device; removing, from the question and from the answer by the artificial intelligence engine, at least one of: personally identifiable information of the user, voice information of the user, or imagery of the user; and storing, in the contact center knowledgebase, the question and the answer as the stored prompt and the stored response.

In Example 37, the subject matter of Examples 33-36 includes, wherein the processor is configured to execute instructions stored in the memory to: add the stored prompt and the stored response to the contact center knowledgebase by: receiving, from an administrator device, the stored prompt and the stored response for storage in the contact center knowledgebase.

In Example 38, the subject matter of Examples 33-37 includes, wherein receiving the query from the user device comprises: prompting, by the chat bot, a user of the user device to specify a reason for the contact center engagement; and receiving the query from the user device in response to prompting the user.

In Example 39, the subject matter of Examples 33-38 includes, wherein the chat bot is configured, using a natural language processing engine, to perform at least one of text communication, audio communication, or video communication.

In Example 40, the subject matter of Examples 33-39 includes, wherein providing the stored response to the user device comprises: providing a link to a page comprising text or a video representing the stored response.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
receiving, during a contact center engagement and via a chat bot of a contact center server, a query from a user device;
determining that the query corresponds to a stored prompt associated with a stored response in a contact center knowledgebase by:
mapping the query to an input vector representing a meaning of the query using a semantic engine, and
determining that a distance between the input vector and a stored vector corresponding to a meaning of the stored prompt is less than or equal to a threshold distance; and
providing, via the chat bot, the stored response to the user device.

2. The method of claim 1, wherein the query comprises text, wherein receiving the query from the user device comprises:
receiving a query comprising audio from the user device; and
generating the query comprising text by applying a speech-to-text engine to the received query comprising audio.

3. The method of claim 1, wherein receiving the query from the user device comprises:
prompting a user of the user device to specify a reason for the contact center engagement; and
receiving the query in response to prompting the user.

4. The method of claim 1, wherein the chat bot is configured, using a natural language processing engine, to perform audio communication in a spoken language.

5. The method of claim 1, wherein providing the stored response to the user device comprises:
providing a link to a page including a representation of the stored response.

6. A non-transitory computer readable medium storing instructions operable to cause one or more processors to perform operations comprising:
receiving, during a contact center engagement and via a chat bot of a contact center server, a query from a user device;
determining that the query corresponds to a stored prompt associated with a stored response in a contact center knowledgebase by:
mapping the query to an input vector representing a meaning of the query using a semantic engine, and
determining that a distance between the input vector and a stored vector corresponding to a meaning of the stored prompt is less than or equal to a threshold distance; and
providing, via the chat bot, the stored response to the user device.

7. The computer readable medium of claim 6, wherein the query comprises text, wherein receiving the query from the user device comprises:
receiving an audio or video query from the user device; and
generating the query by applying a speech-to-text engine to the received audio or video query.

8. The computer readable medium of claim 6, the operations comprising:
adding the stored prompt and the stored response to the contact center knowledgebase by:
recording a contact center engagement between a second user device and an agent device;
determining, using an artificial intelligence engine, a question of a user of the second user device and an answer provided by the agent of the agent device;
removing, from the question and from the answer by the artificial intelligence engine, at least one of: personally identifiable information of the user, voice information of the user, or imagery of the user; and
storing, in the contact center knowledgebase, the question and the answer as the stored prompt and the stored response.

9. The computer readable medium of claim 6, the operations comprising:
adding the stored prompt and the stored response to the contact center knowledgebase by:
receiving, from an administrator device, a question and an answer; and
storing the received question and the received answer as the stored prompt and the stored response in the contact center knowledgebase.

10. The computer readable medium of claim 6, wherein receiving the query from the user device comprises:
prompting, by the chat bot, a user of the user device to specify a reason for the contact center engagement; and
receiving the query in response to prompting the user.

11. The computer readable medium of claim 6, wherein the chat bot is configured, using a natural language processing engine, to perform at least one of text communication or audio communication in a natural language.

12. The computer readable medium of claim 6, wherein providing the stored response to the user device comprises:
providing a link to a video representing the stored response.

13. An apparatus comprising:
a memory; and
a processor configured to execute instructions stored in the memory to:
receive, during a contact center engagement and via a chat bot of a contact center server, a query from a user device;
determine that the query corresponds to a stored prompt associated with a stored response in a contact center knowledgebase by:
mapping the query to an input vector representing a meaning of the query using a semantic engine, and
determining that a distance between the input vector and a stored vector corresponding to a meaning of the stored prompt is less than or equal to a threshold distance; and
provide, via the chat bot, the stored response to the user device.

14. The apparatus of claim 13, wherein the processor is configured to execute instructions stored in the memory to:
determine that the query does not correspond to the stored prompt in the data repository; and
transmit the question to an agent device for manual processing in response to determining that the query does not correspond to the stored prompt.

15. The apparatus of claim 13, wherein the query is a text query, wherein receiving the query from the user device comprises:
receiving an audio or video query from the user device; and
generating the text query by applying a speech-to-text engine to the received audio or video query.

16. The apparatus of claim 13, wherein the processor is configured to execute instructions stored in the memory to:
add the stored prompt and the stored response to the contact center knowledgebase by:
recording a contact center engagement between a client device and an agent device;
determining, using an artificial intelligence engine, a question of a user of the client device and an answer provided by the agent of the agent device;
removing, from the question and from the answer by the artificial intelligence engine, at least one of: personally identifiable information of the user, voice information of the user, or imagery of the user; and
storing, in the contact center knowledgebase, the question and the answer as the stored prompt and the stored response.

17. The apparatus of claim 13, wherein the processor is configured to execute instructions stored in the memory to:
add the stored prompt and the stored response to the contact center knowledgebase by: receiving, from an administrator device, the stored prompt and the stored response for storage in the contact center knowledgebase.

18. The apparatus of claim 13, wherein receiving the query from the user device comprises:
prompting, by the chat bot, a user of the user device to specify a reason for the contact center engagement; and
receiving the query from the user device in response to prompting the user.

19. The apparatus of claim 13, wherein the chat bot is configured, using a natural language processing engine, to perform at least one of text communication, audio communication, or video communication.

20. The apparatus of claim 13, wherein providing the stored response to the user device comprises:
providing a link to a page comprising text or a video representing the stored response.
